(19) United States
(12) Patent Application Publication
(10) Pub. No.: US 2025/0235773 A1
(43) Pub. Date: Jul. 24, 2025

(54) Score Reporting

(71) Applicant: SchoolDuels, Inc., Lutherville, MD (US)

(72) Inventors: John Steuart, Boyton Beach, FL (US); Jake Shipley, White Hall, MD (US)

(21) Appl. No.: 19/031,115

(22) Filed: Jan. 17, 2025

Related U.S. Application Data
(60) Provisional application No. 63/622,336, filed on Jan. 18, 2024.

(51) Int. Cl. A63B 71/06; G06V 20/30

(52) U.S. Cl. CPC A63B 71/06; G06V 20/30; G06V 2201/02

(57) ABSTRACT

Embodiments of this disclosure provide systems, methods, and computer storage media for score reporting of sporting events and implementing mechanisms for verifying and validating the scores through confidence interval calculations associated with reporting sources. In operation, the method receives, at a server, a score associated with a sporting event from an account associated with the sporting event. The account can be for individuals, such as a coach or an administrator, associated with a team participating in the sporting event. The method also calculates a confidence interval associated with the score by a confidence interval, where the confidence interval indicates an accuracy of the score based on the account providing the score, and generating a user interface that displays the score and the confidence interval on a web interface.

### PRIORITY INFORMATION

The present application for patent claims priority under 35 U.S.C. § 119 to U.S. Provisional Patent Application No. 63/622,336, filed Jan. 18, 2024 and entitled “Score Reporting,” which is hereby expressly incorporated by reference herein.

### TECHNICAL FIELD

This disclosure relates generally to sports score reporting verification and, more specifically, to implementing mechanisms for verifying and validating score reporting through confidence interval calculations associated with reporting sources.

### BACKGROUND

There is a vast ecosystem of youth, amateur, and community-based sports structures that operate on a regional or national scale. These organizations can provide opportunities for athletes of all ages and avenues for skill development, competition, and fitness promotion. These structures include, but are not limited to, youth leagues and club sports, National governing bodies for Olympic and amateur sports, recreational leagues, National Championship Circuits (e.g., United States Specialty Sports Association (USSSA), National Travel Circuits), and interscholastic sports (e.g., High School sports).

Interscholastic sports, for instance, typically follow a structured system designed to provide students with opportunities to learn athletic skills, compete against other schools, and develop skills like teamwork, leadership, and discipline. Governing bodies, such as the National Federation of State High School Associations (NFHS) and the State Athletic Associations, can set overarching rules and guidelines for most high school sports. They can develop playing rules and oversee best practices.

These sport ecosystems facilitate thousands of games each year spanning a wide array of sports. Playoffs, tournaments, and other additional games are also played based on a player's or team's record, scores, and schedules. Typically, the teams with the best records play against each other to determine the champion of that league or organization for that year.

### SUMMARY

The systems, methods and devices of this disclosure each have several innovative aspects, no single one of which is solely responsible for the desirable attributes disclosed herein.

One innovative aspect of the subject matter described in this disclosure can be implemented in a system for calculating confidence intervals associated with scores of sporting events submitted to the system. The system includes a verification server configured to store and verify accounts associated with sports teams. The accounts have secure access for reporting and verifying scores of sporting events associated with the sports teams, respectively. The system also includes a crowdsourced input channel configured to receive the scores of the sporting events from attendees at the sporting events and a confidence interval calculator configured to calculate confidence intervals for the scores received from the accounts and the attendees. The confidence intervals indicate the accuracy of the scores. The system further includes a user interface configured to display the scores and the confidence intervals associated with each of the scores on a computing device.

Another innovative aspect of the subject matter described in this disclosure can be implemented in a method for calculating confidence intervals associated with scores of sporting events submitted to a score reporting system operating on a computing device. The method includes receiving, at a server, a score associated with a sporting event from an account associated with the sporting event and calculating a confidence interval associated with the score by a confidence interval calculator on the server. The confidence interval indicates an accuracy of the score based on the account. The method further includes generating a user interface that displays the score and the confidence interval on a web interface.

In some examples, the method includes transmitting a request for the score via a crowdsourced input channel hosted by the server, receiving, at the server, a second score from the crowdsourced input channel, and calculating the confidence interval for the score based, at least partially, on the second score.

Another innovative aspect of the subject matter described in this disclosure can be implemented on a computer storage media storing computer-useable instructions that, when executed by one or more computing devices, cause the one or more computing devices to perform operations that cause the computing devices to calculate confidence intervals associated with scores of sporting events submitted to a score reporting system operating on the computing devices. The operations receive, at a server, a score associated with a sporting event from an account associated with the sporting event, and a confidence interval associated with the score is calculated using a confidence interval calculator on the server. The confidence interval indicates an accuracy of the score based on the account. The operations also generate a user interface to display the score and the confidence interval on a web interface.

This summary is intended to introduce a selection of concepts in a simplified form that is further described in the detailed description section of this disclosure. The summary is not intended to identify key or essential features of the claimed subject matter, nor is it intended to aid in determining the scope of the claimed subject matter. Additional objects, advantages, and novel features of the technology will be set forth in the following description and, in part, will become apparent to those skilled in the art upon examination of the disclosure or learned through practice of the technology.

### BRIEF DESCRIPTION OF THE DRAWINGS

These and other features, aspects, and advantages of the embodiments of the disclosure will become better understood with regard to the following description, appended claims, and accompanying drawings where:

FIG. 1 illustrates a schematic diagram of an exemplary environment in which a score reporting system can operate, in accordance with embodiments of the present disclosure.

FIG. 2 illustrates a block diagram of an exemplary computing device that supports processes and functionalities of a score reporting system, in accordance with embodiments of the present disclosure.

FIG. 3 illustrates a diagram of a score reporting system for obtaining scores from sporting events and calculating confidence intervals associated with those scores, in accordance with embodiments of the present disclosure.

FIGS. 4A and 4B show example interfaces displaying event score requests on a wireless communication device utilizing the score reporting system, in accordance with embodiments of the present disclosure.

FIG. 5 shows an example interface displaying event scores on a wireless communication device utilizing the score reporting system, in accordance with embodiments of the present disclosure.

FIG. 6 illustrates a flow chart of calculating confidence intervals associated with event scores of sporting events, in accordance with embodiments of the present disclosure.

While the present disclosure is amenable to various modifications and alternative forms, specifics thereof, have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

This disclosure relates generally to sports score reporting verification and, more specifically, to implementing mechanisms for verifying and validating score reporting through confidence interval calculations associated with reporting sources. The following description is directed to some particular examples for the purpose of describing innovative aspects of this disclosure. However, a person having ordinary skill in the art will readily recognize that the teachings herein can be applied in a multitude of different ways.

### Overview

In many sports leagues, the number of regular-season games varies by sport. For instance, football teams usually play around 8 to 10 games, while basketball teams can have 20 to 25 games. The total number of games played across all teams in a league depends primarily on the number of participating teams and the scheduling format (e.g., single round-robin vs. double round-robin). In a common high school scenario with, say, 8 to 10 teams, each team might play every other team at least once or twice during the regular season. For instance, if 8 teams play each other twice (home and away), each individual team would have 14 league games (7 opponents×2 games each). Summed across all 8 teams, the league would see 56 total games.

Rankings are primarily determined by win-loss records, though some leagues use point systems, computer-based formulas, or selection committees to factor in the strength of schedule, scoring margins, and other metrics. At the end of the regular season, teams typically enter a bracket-style playoff, often single-elimination, where higher seeds face lower seeds in the initial rounds. In many states, schools compete in district or regional tournaments first, with winners advancing to sectional or state-level championships, commonly held at neutral sites. Beyond the high school realm, youth and club teams might continue on to national tournaments, often involving round-robin group play before transitioning to knockout stages.

In most high school and youth leagues, the home team (or event host) is typically responsible for recording and submitting the final game score. Immediately after the contest, the officials confirm the final tally and the home team's athletic staff, or a designated scorekeeper will enter or report it through the league's approved method, the state athletic association's website, or a specialized scheduling and results system.

Limitations on score reporting remain, however, as some leagues still allow or require manual submission, such as faxing or emailing an official score sheet signed by the referees. Local media outlets, such as newspapers or community sports websites, may also receive score reports via phone, text message, or email so that fans and the broader public stay informed. One common challenge with having the home team or host organization handle score reporting is the potential for data entry mistakes: human error can lead to typos, reversed scores, or other inaccuracies, especially if the submission is done manually or under time pressure. Another issue is inconsistent or delayed reporting since schools or clubs may vary in how quickly they submit their result. Some might upload scores right after the final whistle, while others may not report until days later or not at all, causing gaps in the record.

Furthermore, there can be discrepancies in the official confirmation, where visiting teams might dispute the final score if they feel it was entered incorrectly and there is no reliable system (like signed, verifiable forms or digital verification) to correct or confirm errors. Smaller or less technologically resourced programs may also face technical hurdles, such as unreliable internet access or limited staff familiarity with online submission systems. All of these factors can make it difficult for leagues to maintain up-to-date and accurate standings, records, and statistics.

Embodiments of the present disclosure improve the existing technologies described herein, as well as others, by providing a score reporting system and method that provides a centralized location for reporting scores of sporting events that calculates a confidence interval for those scores based on various factors. These factors include, but are not limited to, the account submitting the score, whether an image was provided, multiple submissions, and crowdsourced information. Embodiments provide account creation services for specific users associated with a team, such as a coach, coordinator, athletic director, and authorized personnel. These users can create accounts that can then submit scores after a game is finalized. Embodiments allow users to submit scores on their own as well as receive prompts from the system once a game is scheduled to be completed to remind users to submit their scores. After the scores are submitted to the score reporting system, the system can calculate a confidence interval based at least on the factors described above and display the scores and confidence interval on the score reporting system's website and/or application. In some embodiments, the score reporting system can adjust the confidence interval as score reporting is received. If a confidence interval remains low or if no score has been submitted, the system can query associated accounts of the teams or players requesting a final score.

More specifically, embodiments improve upon prior techniques by providing a means for players and teams to confidently submit scores to the score reporting system and receive assurance that the score is accurate based on the confidence interval associated with each displayed score. Additionally, embodiments improve upon prior techniques by providing accounts with a means to dispute and resolve scores that otherwise may be difficult to adjust. The scores of various teams across various associations and sports can be displayed on a website with the associated confidence intervals showing the accuracy of each final score. As such, the score reporting system optimizes score aggregation across sporting leagues while also providing a means of ensuring the validity of those reported scores.

### Example Computing Environment

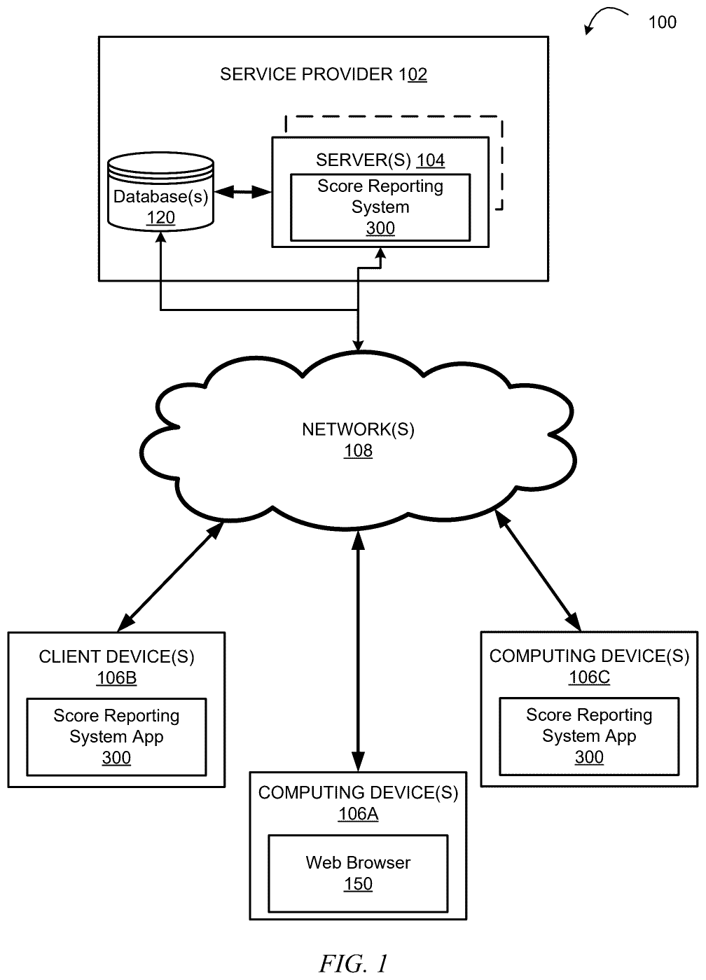

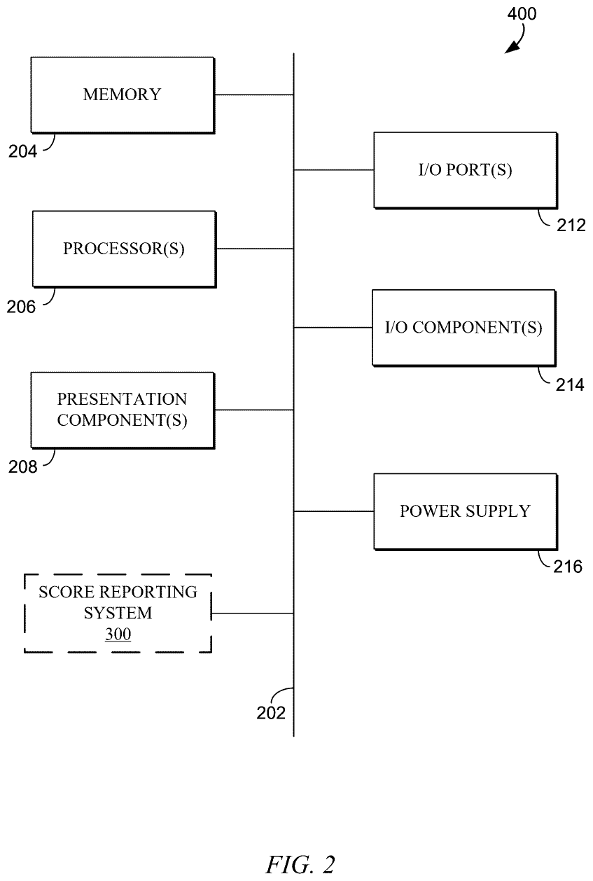

FIG. 1 illustrates a schematic diagram of an exemplary computing environment 100 in which the score reporting system 300 can operate, in accordance with one or more embodiments of the present disclosure. In one or more embodiments, the computing environment 100 includes a service provider 102, which may include one or more servers 104 and one or more databases 120 connected to a plurality of computing devices 106A-106C via one or more networks 108. The computing devices 106A-106C, the one or more networks 108, the service provider 102, and the one or more servers 104 may communicate with each other or other components using any communication platforms and technologies suitable for transporting data and/or communication signals, including any known communication technologies, devices, media, and protocols supportive of remote data communications, examples of which will be described in more detail below with respect to FIG. 2.

Although FIG. 1 illustrates a particular arrangement of the computing devices 106A-106C, the one or more networks 108, the service provider 102, and the one or more servers 104, various additional arrangements are possible. For example, the computing devices 106A-106C may directly communicate with the one or more servers 104, bypassing the network 108. Alternatively, the computing devices 106A-106C may directly communicate with each other. The service provider 102 may be a public cloud service provider that owns and operates its own infrastructure in one or more data centers and provides this infrastructure to customers and end users on demand to host applications on the one or more servers 104. The servers may include one or more hardware servers (e.g., hosts), each with its own computing resources (e.g., processors, memory, disk space, networking bandwidth, etc.), which may be securely divided between multiple customers, each of which hosts their own applications on the one or more servers.

In some embodiments, the service provider may be a private cloud provider who maintains cloud infrastructure for a single organization. The one or more servers 104 may similarly include one or more hardware servers, each with its own computing resources, which are divided among applications (e.g., the score reporting system 300) hosted by the one or more servers 104 for use by members of the organization or their customers.

Similarly, although the computing environment 100 of FIG. 1 is depicted as having various components, the computing environment 100 may have additional or alternative components. For example, the environment 100 can be implemented on a single computing device having the score reporting system 300. In particular, the score reporting system 300 may be implemented in whole or in part on the computing device 106B and/or computing device 106C.

As illustrated in FIG. 1, the environment 100 may include computing devices 106A-106C. The computing devices 106A-106C may comprise any computing device. For example, computing devices 106A-106C may comprise one or more personal computers, laptop computers, mobile devices, mobile phones, tablets, special purpose computers, TVs, or other computing devices, including computing devices described below with regard to FIG. 2. Although three computing devices are shown in FIG. 1, it will be appreciated that computing devices 106A-106C may comprise any number of computing devices (greater or smaller than shown).

Moreover, as illustrated in FIG. 1, the computing devices 106A-106C, the one or more servers 104, and the one or more databases 120 may communicate via one or more networks 108. The one or more networks 108 may represent a single network or a collection of networks (such as the Internet, a corporate Intranet, a virtual private network (VPN), a local area network (LAN), a wireless local network (WLAN), a cellular network, a wide area network (WAN), a metropolitan area network (MAN), or a combination of two or more such networks. Thus, the one or more networks 108 may be any suitable network over which the computing devices 106A-106C may access service provider 102, server 2004, database 120, or vice versa. The one or more networks 108 will be discussed in more detail below with regard to FIG. 2.

In addition, the computing environment 100 may also include one or more servers 104. The one or more servers 104 may generate, store, receive, and transmit any type of data, including communications and data produced by the score reporting system 300, or other information. For example, a server 104 may receive data from a computing device, such as the computing device 106A, and send the data to another computing device, such as the computing device 102B and/or 102C. The server 104 can also transmit electronic messages between one or more users of the environment 100. In one example embodiment, the server 104 is a data server. The server 104 can also comprise a communication server, a verification server, an administration webserver, or a web-hosting server. Additional details regarding the server 104 will be discussed below with respect to FIG. 2.

As mentioned, in one or more embodiments, the one or more servers 104 can include or implement at least a portion of the score reporting system 300. In particular, the score reporting system 300 can comprise an application running on the one or more servers 104, or a portion of the score reporting system 300 can be downloaded from the one or more servers 104. For example, the score reporting system 300 can include a web hosting application that allows the computing devices 106A-106C to interact with content hosted at the one or more servers 104. To illustrate, in one or more embodiments of the environment 100, one or more computing devices 106A-106C can access a webpage supported by the one or more servers 104. In particular, the computing device 106A can run a web application (e.g., a web browser) to allow a user to access, view, and/or interact with a webpage or website hosted at the one or more servers 104.

Upon the computing device 106A accessing a webpage or other web application hosted at the one or more servers 104, in one or more embodiments, the one or more servers 104 can provide access to authorized accounts that allow users to report score for sporting events they are associated with and can be stored on the one or more databases 120 by the one or more servers 104. Moreover, the computing device 106A can receive a request (i.e., via user input) to provide event scores for events authorized accounts are associated with operating the computing device 106A and provide the event scores to the one or more servers 104. Upon receiving the scores, the one or more servers 104 can automatically perform the methods and processes described below. The one or more servers 104 can provide all or portions of the event scores and associated confidence intervals to the computing device 106A for display to the user.

As just described, the score reporting system 300 may be implemented in whole, or in part, by the individual elements 102-2120 of the computing environment 100. It will be appreciated that although certain components of the score reporting system 300 are described in the previous examples with regard to particular elements of the computing environment 100, various alternative implementations are possible. For instance, in one or more embodiments, the score reporting system 300 is implemented on any of the computing devices 106A-106C. Similarly, in one or more embodiments, the score reporting system 300 may be implemented on the one or more servers 104. Moreover, different components and functions of score reporting system 300 may be implemented separately among computing devices 106A-106C, the one or more servers 104, the one or more databases 120, and the network 108.

Embodiments of the present disclosure may comprise or utilize a special-purpose or general-purpose computer, including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., a memory, etc.) and executes those instructions, thereby performing one or more processes, including one or more of the processes described herein.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry desired program code means in the form of computer-executable instructions or data structures and which can be accessed by a general-purpose or special-purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data that, when executed at a processor, cause a general-purpose computer, special-purpose computer, or special-purpose processing device to perform a certain function or group of functions. In some embodiments, computer-executable instructions are executed on a general-purpose computer to turn the general-purpose computer into a special-purpose computer, implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, handheld devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as on-demand self-service, broad network access, resource pooling, rapid elasticity, measured service, and so forth. A cloud-computing model can also expose various service models, such as, for example Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud-computing environment” is an environment in which cloud computing is employed.

### Example Computing Device

Having described an overview of embodiments of the present technology, an example operating environment in which embodiments of the present technology may be implemented is described in order to provide a general context for various aspects of the present technology. Referring now to FIG. 2, in particular, an exemplary operating environment for implementing embodiments of the present technology is shown and designated generally as computing device 2. Computing device 200 is but one example of a suitable computing environment and is not intended to suggest any limitation as to the scope of use or functionality of the technology. Neither should computing device 200 be interpreted as having any dependency or requirement relating to any one or combination of components illustrated.

The technology of the present disclosure may be described in the general context of computer code or machine-useable instructions, including computer-executable instructions such as program modules, being executed by a computer or other machines, such as a personal data assistant or other handheld devices. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 2, computing device 2 includes bus 202 that directly or indirectly couples the following devices: memory 2104, one or more processors 206, one or more presentation components 208, input/output port(s) 212, input/output components 214, and a power supply 216. These components are configured to operate the steps, methods, and processes described by the score reporting system 300 in whole or in part. Bus 202 represents what may be one or more buses (such as an address bus, data bus, or combination thereof). Although the various blocks of FIG. 2 are shown with lines for the sake of clarity, in reality, delineating various components is not so clear, and metaphorically, the lines would more accurately be grey and fuzzy. For example, one may consider a presentation component, such as a display device, or an I/O component. Also, processors have memory. We recognize that such is the nature of the art and reiterate that the diagram of FIG. 2 merely illustrates an example computing device that can be used in connection with one or more embodiments of the present technology. A distinction is not made between such categories as “workstation,” “server,” “laptop,” “handheld device,” etc., as all are contemplated within the scope of FIG. 21 and reference to “computing device.”

Computing device 200 typically includes a variety of computer-readable media. Computer-readable media can be any available media that can be accessed by computing device 200 and includes both volatile and nonvolatile media, removable and non-removable media. By way of example, and not limitation, computer-readable media may comprise computer storage media and communication media.

Computer storage media include volatile and nonvolatile, removable, and non-removable media implemented in any method or technology for storage of information, such as computer-readable instructions, data structures, program modules, or other data. Computer storage media includes but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 200. Computer storage media excludes signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 204 includes computer storage media in the form of volatile or nonvolatile memory. The memory may be removable, non-removable, or a combination thereof. Examples of hardware devices include solid-state memory, hard drives, optical disc drives, etc. Computing device 200 includes one or more processors 206 that read data from various entities, such as memory 204 or I/O components 212. Presentation component(s) 208 presents data indications to a user or other device. Examples of presentation components include a display device, speaker, printing component, vibrating component, etc.

I/O components 212, using the I/O ports 212, allow the computing device 200 to be logically coupled to other devices, some of which may be built in. Illustrative components include a microphone, joystick, game pad, satellite dish, scanner, printer, wireless device, etc.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions, etc.) can be used in addition to or instead of those shown.

### Example Score Reporting System

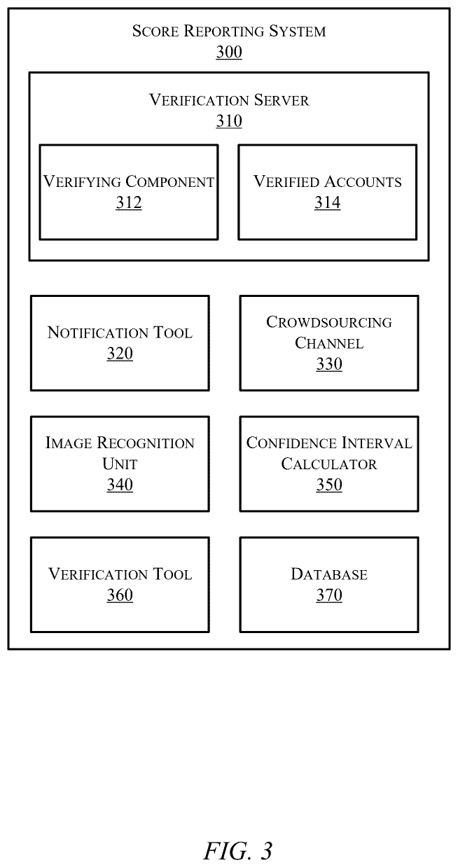

Referring now to FIG. 3, a block diagram of an example score reporting system 300 suitable for use in implementing embodiments of the disclosure is shown. The score reporting system 300 is configured to collect scores from various sporting events from authorized accounts, crowdsourced individuals, and scoreboard images. The score reporting system 300 can utilize various algorithms and weighing mechanisms to calculate confidence intervals for the scores being reported. As discussed, the score reporting system 300 can receive scores from various reporting sources, such as verified accounts and crowdsourced channels, as well as from images submitted to the score reporting system 300. Once received, the score reporting system 300 can verify the score and calculate a corresponding confidence interval before displaying the score and confidence interval on a web application or website.

The score reporting system 300 can be implemented as a standalone application or as part of another application or suite of applications. For example, the score reporting system 300 can be implemented as part of a suite of sporting event applications and services, enabling the score reporting and confidence interval analysis to be a module of the sporting event suite.

The score reporting system 300 can include a verification server 310, a notification tool 320, a crowdsourced input channel 330, an image recognition unit 340, a confidence interval calculator 350, a score verification tool 360, and a database 370. The verification server 310 can include a verifying component 312 and a verified account storage component 314.

The verification server 310 is a component of the score reporting system 300 configured to provide server services that facilitate the various mechanisms of the score reporting system 300. In some implementations, the verification server 310 is a monolithic server deploying various virtual servers, and in other implementations, the verification server 310 includes a collection of servers that operate the various components of the score reporting system 300. As an example, the verification server 310, operating as one machine (physical or virtual) would simultaneously run a web server, which serves both the public front-end and the administrative interface, as well as a core application layer that handles authentication, data processing, and business logic. In some implementations, the database 370 can also reside on this same server, enabling a single point of data storage for users, scores, schedules, and media.

The verification server 310 is further configured to support both verified user endpoints and crowdsourced data submissions, distinguishing between official and user-generated inputs while storing them in the central database 370.

In some implementations, the verification server 310 includes an administration webserver that hosts an administrative interface for authorized personnel (e.g., authorized accounts). The administrative interface can be used by users with authorized accounts, such as league managers, team coaches, school administrators, and the like, to input, validate, or manage official data associated with their respective team or teams (e.g., official scores, rosters, schedules).

In some implementations, the verification server 310 includes an application server that hosts an end-user web server and a mobile application. These components can provide a front-end or user interface for individuals such as fans, parents, players, or the general public to view scores and results, highlights, recaps, photos, and various other content related to sporting events. In some implementations, the application server provides push notifications and real-time updates through web sockets or a message broker.

The verification server 310 can also include a verifying component 312 configured to ensure the authorized accounts are associated with valid users such as coaches, administrators, and athletic directors. In some implementations, the verifying component 312 can implement a multi-step registration process designed to confirm that the user is who they claim to be. First, when a new user attempts to create an account, the verifying component 312 can collect basic information (e.g., username, email address, and potentially a phone number).

The verifying component 312 can then generate a unique verification token or code and send it to the user via email (a confirmation link) or SMS (a numeric code). The user must click the link or enter the code back into the system to prove they control that email address or phone. Upon successful completion of this step, the verifying component 312 can update the user record to reflect a “verified” or “active” status, granting access to the score reporting system's 300 features. If extra security or role-based authorization is needed (for example, “admin” or “league manager”), an additional approval step can be implemented, where a human administrator reviews and explicitly grants higher access privileges. Upon registration completion, the authorized account and their corresponding information can be stored on the verified accounts data store 314.

The notification tool 320 is a component of the score reporting system 300 configured to provide notification messages to accounts associated with sporting events currently being played. When a game concludes, and the score reporting system 300 needs a final score, the notification tool 320 can use an event-driven workflow that triggers notifications to the relevant accounts (for example, verified scorers, league officials, or other authorized users). As soon as the notification tool 320 records that a contest has ended, either through an automated update (e.g., via an external data feed) or manual input (e.g., an official clicks “Game Complete”), it generates a “score submission needed” event. This event feeds into the notification tool's 320 notification/relay service (which can be an internal module or a lightweight messaging queue), which decides how and where to send alerts. Depending on user preferences and roles, the notification tool 320 can dispatch an email with a link to the score-submission page, send an SMS containing a prompt to reply with the results or issue a push notification to the mobile app.

In some implementations, the notification can contain a unique token or reference that points to the specific game, so once the designated user taps the link or opens the app, they are taken directly to the data-entry screen. There, they can submit the final score or confirm that the crowd-submitted results match what actually happened. The notification tool 320 can then update the database 370 accordingly and either publish the results immediately (for verified users) or forward them into the verification process (if a crowdsourced submission requires an admin's final approval).

The crowdsourced input channel 330 is a component of the score reporting system 300 configured to receive scores and event data from the general public (e.g., users who are not necessarily official scorers or league administrators). The crowdsourced input channel 330 provides a route through which these unverified submissions can enter the score reporting system 300. These routes include, but are not limited to, a public form on the website, a mobile app feature (e.g., “Submit Score”), or a text-in service. The crowdsourced input channel 330 can set aside these community-provided results separately from those submitted by verified sources, allowing the score reporting system 300 to calculate a confidence interval before publishing the provided scores.

When a score is submitted, each crowdsourced submission can be labeled as “unverified” until it meets certain criteria—this could include matching data from other crowd submissions, correlating with partial official updates, or passing an administrator's manual review. In some implementations, the crowdsourced input channel 330 uses “confidence scores” or weighting systems: if multiple independent users provide the same score, the confidence increases; if contradictory submissions appear, the system might flag them for extra scrutiny. The crowdsourced input channel 330 attempts to collect all relevant crowd data, then can either automatically promote it to “verified” status if it meets confidence thresholds once a confidence interval is determined or forwards it to an administrator for final review. This helps ensure the data being published is as accurate as possible while still leveraging a wide base of community input.

The image recognition unit 340 is a component of the score reporting system 300 configured to receive and analyze images to derive scores of sporting events. The image recognition unit 340 can apply computer vision techniques to locate text regions of an image, using optical character recognition (OCR) to read the text and then apply a sports-specific validation to extract scores from the image. For example, an account user can upload a photo of a scoreboard (e.g., in a basketball arena) to the score reporting system 300. The image recognition unit 340 can preprocess the image to adjust characteristics of the image such as tilt, brightness, and crop out any unnecessary background. Using computer vision techniques, the image recognition unit 340 can identify scoreboard numbers and team names (e.g., “Lakeview 89” and “Channelbrook 81”) and extract the relevant bounding boxes for those words. The image recognition unit 340 can then utilize validation techniques to match the team names with known teams in an association the score reporting system 300 follows and that the scores are within a plausible range for the type of sporting being played. The final data can then be passed on for display and/or confidence interval calculations.

In some implementations, the image recognition unit 340 can acquire images from various sources such as a camera capture, scanner, fax, document upload, or video frame extraction. For instance, a user can capture a photo of the scoreboard/score sheet with a smartphone or dedicated camera and upload that image to the score reporting system 300. Once received, the image recognition unit 340 can use various tools to preprocess the image, such as OpenCV or Pillow (Python Imaging Library). Using these tools or others, the image recognition unit 340 can rotate/deskew the image such that the dominant text orientation is properly aligned. In some embodiments, algorithms such as the Hough Transform or a text-detection-based approach (calculating average text angle) are used to align the text. If the scoreboard as photographed from an angle, a perspective correction can be applied using techniques such as four-point transforms or homography.

In some implementations, the image recognition unit 340 applies additional preprocessing techniques such as noise reduction, contrast and brightness adjustment, thresholding, region of interest (ROI) detection, and the like. For instance, if an image is overly dark or overly bright, the image may mask the details. In such cases, the image recognition unit 340 can use techniques such as histogram equalization that improves contrast by spreading out the intensity values of the image, gamma correction to control the brightness, or using simple brightness/contrast controls that can multiply the pixel values by a certain factor and adding/subtracting from them. CCA, for instance, can identify contiguous pixel regions that have similar color or intensity. This can be combined with thresholding and morphological operations (e.g., dilation/erosion) to isolate text clusters.

Once the regions are identified, the image recognition unit 340 can transform the cropped regions identified in the text detection phase into machine-readable strings using techniques such as Tesseract, EasyOCR, Google Cloud Vision OCR, AWS Textract, Microsoft OCR API, and the like. These techniques, or engines, can be configured with “whitelists”/“blacklists” to focus on probable characters (e.g., digits for scores).

In text detection, the image recognition unit 340 can use various techniques to locate and segment areas in the image that contain text. These techniques include but are not limited to, connected component analysis (CCA), maximally stable, extremal regions (MSER), efficient and accurate scene text detector (EAST), and character region awareness for text detection (CRAFT).

Once the OCR returns raw text, the image recognition unit 340 can correspond the text to which field it belongs to (e.g., Team A name, Team A score, Team B name, Team B score). The image recognition unit 340 can use methods such as positional heuristics, keyword detection, and statistical/machine learning-based layout parsing to correspond to the text. Positional heuristics, for instance, can define an expected layout (e.g., scoreboard lines or columns) and use coordinates to map extracted text to the correct fields.

The confidence interval calculator 350 is a component of the score reporting system 300 configured to produce a confidence interval associated with a score that reflects the accuracy believed by the score reporting system 300 for that score. In addition to the reported score, the confidence interval calculator 350 can input additional information such as historical accuracy rates of accounts, source reliability providing the score, consensus among reports, crowdsourced data metrics, and third-party validation.

Historical accuracy rates can relate to the past accuracy of individuals or sources reporting scores. Higher accuracy over time can narrow confidence intervals, indicating greater reliability. Different sources, such as coaches, credentialed officials, or crowdsourced reporters, can be assigned reliability weights based on their role and historical data. For example, scores reported by verified coaches may carry higher reliability than those reported by first-time crowd members. The level of agreement between multiple sources can also contribute to confidence interval calculations. A higher number of matching reports (from independent sources) reduces the interval, indicating a stronger consensus. Additional factors, such as the number of reports for the same score and their geographic proximity to the sporting event, can be considered. Geolocation data (e.g., phone location relative to the event site) can validate the authenticity of the reporter, improving reliability.

In some implementations, the confidence interval calculator 350 calculates the confidence interval based on a combination of weighted averaging of scores from various sources, variance or standard deviation across reports, and adjustments based on predefined reliability metrics. In some embodiments, the confidence interval calculator 350 uses the following weighted mean score Equation 1:

$$Weighted Mean Score = \frac{{\sum }_{i = 1}^{n} {w}_{i} {S}_{i}}{{\sum }_{i = 1}^{n} {w}_{i}} \qquad Equation 1$$

The confidence interval calculator 350 can then use the following confidence interval Equation 2:

$$Confidential Inteval = ( μ - z \frac{σ}{\sqrt{n}} , μ + z \frac{σ}{\sqrt{n}} ) \qquad Equation 2$$

Where μ refers to the weighted mean score, σ refers to the weighted standard deviation, z refers to the Z-score for the desired confidence level (e.g., 1.96 or 95%), and n refers to the number of reports.

In some implementations, the confidence interval calculator 350 aggregates the data by collecting reported scores from all sources (e.g., coaches, crowdsourced channels, and image recognition) and assigns weights to each source based on reliability and historical accuracy. The confidence interval calculator 350 can then perform a consensus analysis to identify the most frequently reported score and calculate the deviation of other reports from this consensus score. Historical data on reporting errors (false scores, inconsistent reports) can also be used to estimate the likely error margin for current scores. In some embodiments, the confidence interval calculator 350 can also adjust the interval width based on the reliability of the sources and the amount of agreement between them.

In some implementations, the confidence interval calculator 350 calculates a confidence interval based on aggregation of multiple score sources, including coaches, athletic directors, members, administrators, and other sources. The confidence interval calculator can dynamically adjust weightings of member contributions based on historical accuracy of their submissions. These sources, by default, can have varying degrees of reliability. For instance, coaches and athletic directors can be given the highest reliability (e.g., 1.0), member submissions can have differing degrees of reliability based on their prior submissions (e.g., 0.5-0.7), and other sources such as external sites can have a default of lower reliability (e.g., 0.3-0.6). Each member can start with a baseline weight (e.g., 0.5) and after each submitted score is confirmed as correct, their weight can be incrementally increased, and in some instances, capped at predetermined weight (e.g., 0.9). When a member submits an incorrect score, their weight can be increased by some predetermined amount, and in some instances, to a floor weight (e.g., 0.1). If the score submissions converge on the same final score for each time, variance can be considered low, and the confidence interval calculator 350 can raise the confidence of that score. However, if sources differ significantly, then the confidence interval calculator 350 can lower the confidence of the score until an official or highly reliable source clarifies the score.

In some embodiments, the confidence interval calculator 350 performs real-time recalculations whenever scores are submitted or updated. The confidence interval calculator 350 can employ weighted reliability measures, giving the highest weight to users of accounts with an association type of coach or athletic director, and so forth. For each team's final score, the confidence interval calculator 350 can compute a weighted mean for all reported scores. A weighted mean and variance approach can underpin the confidence calculations, producing a probabilistic measure of reliability for individual scores and overall game outcomes. The confidence interval calculator 350 can then calculate a variance or standard deviation of these scores. A narrower spread (low standard deviation) increases the confidence interval and a wider spread (high standard deviation) decreases the confidence interval.

In some implementations, the confidence interval calculator calculates a score-level confidence using the following Equation 3:

$$μ = \frac{{\sum }_{i = 1}^{n} ( {x}_{i} \times {w}_{i} )}{{\sum }_{i = 1}^{n} {w}_{i}} \qquad Equation 3$$

Where xᵢ represents each submitted score, wᵢ represents the corresponding weight based on the source, and y represents the weighted mean for that score. The confidence interval calculator 350 can computer the variance or standard deviation using weighted metrics and derive a confidence percentage using a probabilistic model (e.g., a normal approximation) that decreases with higher variance and increases with higher reliability sources. Once each team's final score has a confidence value, the confidence interval calculator 350 can combine them to estimate the probability that the first team's score exceeds the second team's score.

In some embodiments, the confidence interval calculator 350 assigns a color-coded indicator to the score based on the calculated confidence interval. For instance, each team's final score with a confidence interval percentage (e.g., 95% confident) and color-coded (e.g., green, yellow, red). As an example, a single probability that Team 1 defeated Team 2 based the aggregated sources with a 98.5% confidence interval. Each team score can also have a produced confidence interval such as Team 1 having a score of 35 with a 99% confidence interval and a green color coded indicator, Team 2 having a score of 20 with a 82% confidence interval and a yellow color coded indicator, and the over all score with the mentioned 98.5% confidence interval color coded green. The color codings can be predetermined with such as green color indicating a high confidence percentage such as 90-100%, yellow between 70-90%, and red for any confidence score below 70%. It should be noted that other percentages can be used and this is merely an example.

The verification tool 360 is a component of the score reporting system 300 configured to provide verification of accounts and scores. In some implementations, when scores are initially reported by authorized coaches or other verified personnel (e.g., referees, managers), the verification tool 360 can prompt opposing teams' coaches or officials to confirm the reported score via a secure SMS line or other communication channels. If both teams' coaches report or confirm the same score, the verification tool 360 can mark it as verified. Scores reported by coaches are given high-reliability weights due to their role and authentication through secured accounts.

In some implementations, in instances where there are no verified scores reported by the coaches within a predetermined timeframe, the verification tool 360 can allow the crowdsourcing channel 330 to receive crowdsourced scores. In those instances, scores can submitted by spectators or other individuals present at the event, who are authenticated through the score reporting system 300 (e.g., verified via email, phone numbers, or account history). The verification tool 360 can calculate the most frequently reported score among the scores, and a score can be verified if multiple independent reports match the same value. As described, each crowdsource member can be assigned a reliability rating based on their history of accurate score reporting. Scores reported by individuals with higher confidence ratings are weighted more heavily in the verification process.

In some implementations, the verification tool 360 verifies scores derived from images using the image recognition unit 340. The verification tool 360 can cross-validate extracted scores by comparing them with reported scores from coaches and crowdsourced sources. If the image-processed score matches other reported scores, it enhances the confidence in the verification. In some implementations, the verification tool 360 uses third-party validation by searching external platforms (e.g., social media, high school websites, league pages) for mentions of the game's score. Scores found on reliable third-party sources can be used to validate or corroborate reported scores.

In some implementations, the verification tool 360 tracks the individual history of reported scores. Each reporter, whether a coach or crowd member, has a historical accuracy record tracked by the verification tool 360. Reporters with a history of providing correct scores are given higher reliability, and their input carries more weight in the confidence interval calculations. Scores reported by verified coaches or officials can have the highest weight, while scores reported by new or less reliable crowd members can be treated as provisional until corroborated by others.

In some implementations, when a score remains unverified, the verification tool 360 triggers the confidence interval calculator 350 to calculate a confidence interval. The interval can provide accuracy and confidence for the score provided. The interval can incorporate historical accuracy, consensus level, and reliability of sources. Scores within the calculated confidence interval can be displayed as provisional until a predetermined confidence interval is achieved or until the scores are verified.

It is noted that FIG. 3 is intended to depict the major representative components of a score reporting system 300. In some embodiments, however, individual components may have greater or lesser complexity than as represented in FIG. 3, components other than or in addition to those shown in FIG. 3 may be present, and the number, type, and configuration of such components may vary.

### Example Score Reporting Interfaces

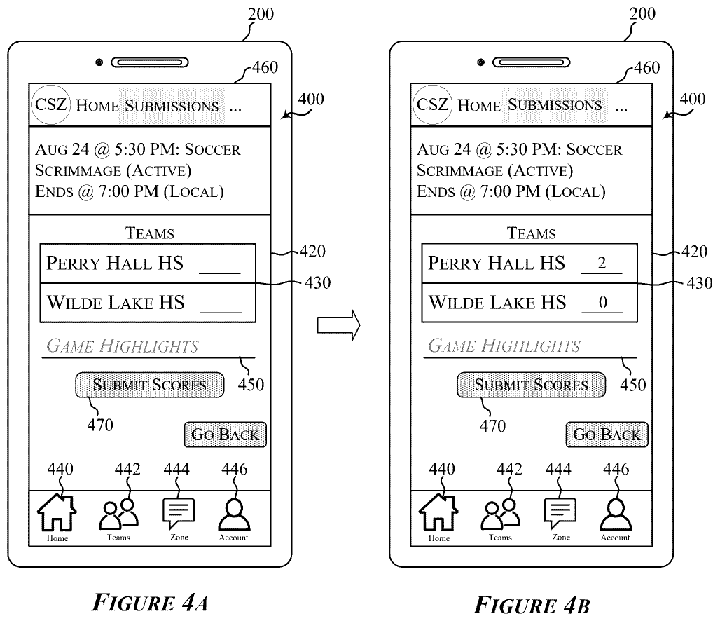

FIGS. 4A and 4B illustrate an example communication interface 400 for text-based communication between a user and a recipient 310 while using the score reporting system 300 on a computing device 200, in accordance with embodiments of the present disclosure. As shown in FIG. 4A, and in this example, the communication interface 400 presents a visualization of communication between the score reporting system 300 and a recipient in a dialog window 420. Additionally, the communication interface 400 includes an input field 430, a home button 440, a teams button 442, a zone button 444, and an account button 446. In this example, the communication interface 400, as shown, displays a notification to a user requesting a score for a sporting event between ‘Perry Hall HS’ and ‘Wilde Lake HS.’ In addition to the score, the user can submit game highlights such as images or video footage, as shown in the submission 450. The score reporting system 300 also provides the interface 400 with a means to navigate the various sections of the mobile application using the top navigation menu 460. As shown, the user is in the submissions tab of the top navigation menu 460, as shown by the shaded region.

At the conclusion of the soccer scrimmage that was scheduled for August 24^{th} at 5:30 PM and ending at 7:00 PM, the score reporting system 300 can transmit a notification in which the user can access an interface such as the interface 400 to submit the scores for that game. The user can be of an authorized account that is associated with either team that is scheduled to play.

As shown in 4B, the user has entered the score for both teams and submitted those scores to the score reporting system 300 by pressing the submit button 470. Upon receiving the score, the score reporting system 300 can verify the score based on the account that is submitting the score and calculate a confidence interval. Both the score and the confidence interval are displayed on the mobile application and website for users to view.

It should be noted that while FIGS. 4A and 4B only show communication between one user and the score reporting system 300, the score reporting system 300 can link any number of user accounts to a sporting event and transmit notifications to each account. It should also be noted that the score reporting system 300 does not require every account to respond with a score and can perform its operations using any score received from the various sources described above.

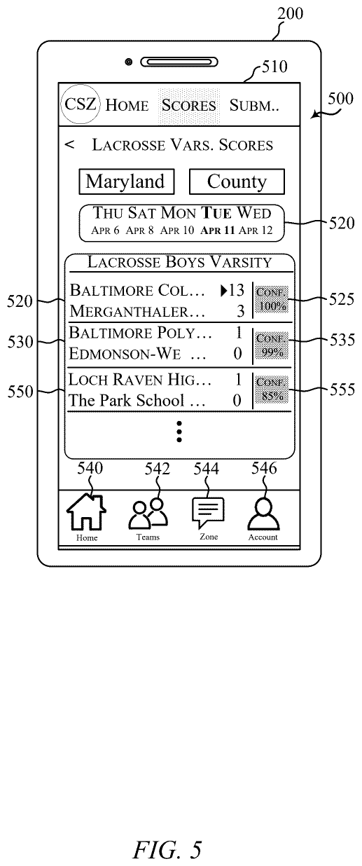

FIG. 5 illustrates an example user interface 500 for score display using the score reporting system 300 on a computing device 200, in accordance with embodiments of the present disclosure. As shown in FIG. 5, and in this example, the user interface 500 presents a visualization of scores of games for teams associated with a lacrosse boys varsity league. The user interface includes a means to navigate the various sections of the mobile application using the top navigation menu 510. As shown, the user is in the scores tab of the top navigation menu 560, as shown by the shaded region. Once selected, the user interface 500 can display a date selection 520 that the user can interact with to select a date, which causes the user interface 500 to display games that were played on that corresponding day. Additionally, the user interface 400 includes scores 520, 530, 545, a home button 540, a teams button 542, a zone button 544, and an account button 546.

In this example, the user interface 500 displays the scores 520, 530, 550, and the corresponding confidence intervals 525, 535, 555. The score reporting system 300 can calculate the confidence intervals 525, 535, 555 as the scores are submitted to the system and then display the score with the highest accuracy in relation to its calculated confidence interval.

Additionally, the communication interface 400 includes an input field 430, a home button 440, a teams button 442, a zone button 444, and an account button 446. In this example, the communication interface 400, as shown, displays a notification to a user requesting a score for a sporting event between ‘Perry Hall HS’ and ‘Wilde Lake HS.’ In addition to the score, the user can submit game highlights such as images or video footage, as shown in the submission 450. The score reporting system 300 also provides the interface 400 with a means to navigate the various sections of the mobile application officer using the top navigation menu 460. As shown, the user is in the submissions tab of the top navigation menu 460, as shown by the shaded region.

### Example Flow Diagram

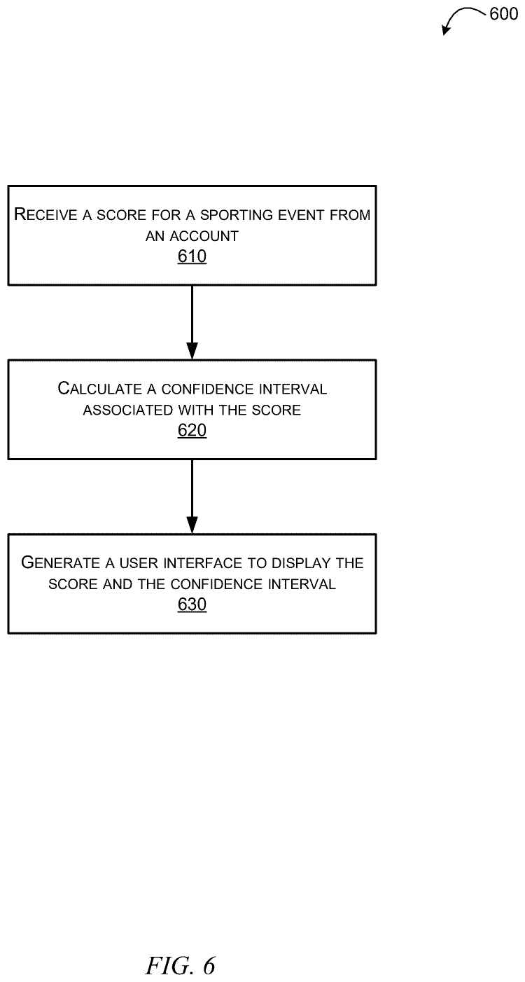

FIGS. 1-5, the corresponding text, and the examples provide a number of different systems that enable the score reporting system 300 to receive scores of sporting events and calculate confidence intervals associated with the scores submitted to the system. In addition to the foregoing, embodiments can also be described in terms of flowcharts comprising acts and steps to accomplish a particular result. For example, FIG. 6 illustrates a flowchart of an exemplary method in accordance with one or more embodiments. The method described in relation to FIG. 6 may be performed with fewer or more steps/acts, or the steps/acts may be performed in differing orders. Additionally, the steps/acts described herein may be repeated or performed in parallel with one another or in parallel with different instances of the same or similar steps/acts.

With reference to FIG. 6, a flow diagram illustrating a method is provided. Each block of the method 600 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media. In some implementations, the methods are provided by a standalone application, a service or hosted service (standalone or in combination with another hosted service), or a plug-in to another product, to name a few.

FIG. 6 shows a flowchart illustrating an example process 600 performable by or at a computing device that supports confidence interval calculation, receiving, and notification operations. The operations of the process 600 may be implemented by a computing device. For example, the process 600 may be performed by a computing device, such as the computing device 200 described with reference to FIG. 2, operating as or within a computing environment, such as the computing environment 100 with reference to FIG. 1.

In block 610, the computing device, via a server operating at least a portion of the score reporting system 300, receives a score associated with a sporting event from an account associated with the sporting event. In some embodiments, the computing device, prior to receiving the score, creates the account for a user associated with a team playing in the sporting event. The account can include an association type of the user for the account. For example, the association type can be that the user is a coach on the team, an administrator, an athletic director, or some type of personnel directly connected with the team. The computing device can also verify the association type of the user with an already verified administrator associated with the team. This can be a principal or league owner who can validate the user is who they claim to be.

In some implementations, if a score for the sporting event is not reported by an account from a coach, or similar, within a predetermined timeframe, the computing device can allow a crowdsourcing channel to receive crowdsourced scores. In those instances, scores can besubmitted by spectators or other individuals present at the event who are authenticated with a crowdsourcing account (e.g., verified via email, phone numbers, or account history).

In some implementations, the computing device receives scores from an image submitted by the account. The computing device can apply computer vision techniques to locate text regions of the image, using OCR to read the text, and then apply a sports-specific validation to extract scores from the image. The computing device can preprocess the image to adjust its characteristics, such as tilt brightness, and crop out any unnecessary background. Using computer vision techniques, the computing device can identify scoreboard numbers and team names and extract the relevant bounding boxes for those words. The computing device can then utilize validation techniques to match the team names with known teams in an association the score reporting system 300 follows, and that the scores are within a plausible range for the type of sporting being played.

At block 620, the computing device calculates a confidence interval associated with the score based on the account, its association type, and any historical data of the account. As described, additional information such as historical accuracy rates of accounts, source reliability providing the score, consensus among reports, crowdsourced data metrics, and third-party validation can be used as factors by the computing device when calculating the confidence interval for the submitted score from the account.

In some implementations, the computing device aggregates the data by collecting reported scores from all sources (e.g., coaches, crowdsourced channels, and image recognition) and assigns weights to each source based on reliability and historical accuracy. The computing device can then perform a consensus analysis to identify the most frequently reported score and calculate the deviation of other reports from this consensus score.

In some implementations, the computing device can prompt opposing teams' coaches or officials to confirm the reported score via a secure SMS line or other communication channels when scores are initially reported by authorized coaches or other verified personnel (e.g., referees, managers). If both teams' coaches report or confirm the same score, the computing device can mark it as verified. Scores reported by coaches are given high-reliability weights due to their role and authentication through secured accounts. At block 630, the computing device, via the score reporting system 300, generates a user interface (UI) displaying the score and its corresponding confidence interval on the computing device. In some implementations, the computing device causes the UI to display multiple scores and confidence intervals of teams associated with the team that are also playing on the same day as the team in the same league. In some implementations, the computing device causes the UI to display a different confidence interval as more information, such as additional score submissions, is submitted to the score reporting system 300.

The subject matter of the present disclosure is described with specificity herein to meet statutory requirements. However, the description itself is not intended to limit the scope of this patent. Rather, the inventor has contemplated that the claimed subject matter might also be embodied in other ways, including different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. For purposes of this disclosure, words such as “a” and “an,” unless otherwise indicated to the contrary, include the plural as well as the singular. Thus, for example, the requirement of “a feature” is satisfied where one or more features are present.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles, and the novel features disclosed herein.

Additionally, various features that are described in this specification in the context of separate examples also can be implemented in combination in a single implementation. Conversely, various features that are described in the context of a single implementation can also be implemented in multiple examples separately or in any suitable sub-combination. As such, although features may be described above as acting in particular combinations and even initially claimed as such, one or more features from a claimed combination can, in some cases, be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order or that all illustrated operations be performed to achieve desirable results. Further, the drawings may schematically depict one or more example processes in the form of a flowchart or flow diagram. However, other operations that are not depicted can be incorporated into the schematically illustrated example processes. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together into a single software product or packaged into multiple software products.

The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. A system for reporting and verifying score from sporting events, the system comprising:
a verification server configured to store and verify accounts associated with sport teams, wherein the accounts have secure access for reporting and verifying scores of sporting events associated with the sport teams, respectively;
a crowdsourced input channel configured to receive the scores of the sporting events from attendees at the sporting events;
a confidence interval calculator configured to calculate confidence intervals for the scores received from the accounts and the attendees, wherein the confidence intervals indicates an accuracy of the scores; and
a user interface configured to display the scores and the confidence intervals associated with each of the scores.

2. The system of claim 1, further comprising a notification tool configured to transmit a notification to the accounts associated with a sporting event at a conclusion of the sporting event, wherein the notification requests a score be submitted to the system from the accounts.

3. The system of claim 1, further comprising a database configured to store schedules associated with the sporting events and account information for the accounts.

4. The system of claim 1, further comprising an image recognition unit configured to receive images of the sporting events and detect the scores within the images associated with the sporting events.

5. The system of claim 4, wherein the image recognition unit is further configured to receive the images from the accounts and from the crowdsourced input channel.

6. The system of claim 4, wherein the image recognition unit is further configured to process multiple formats of scoreboards and stat sheets including digital displays, analog displays, and paper stat sheets to derive the scores.

7. The system of claim 1, wherein the confidence interval calculator factors in a confidence weight associated with each of the accounts that submit the scores when calculating the confidence intervals.

8. The system of claim 1, wherein the crowdsourced input channel is further configured to query the attendees at the sporting events when the score has not been submitted for a game.

9. The system of claim 1, further comprising a score verification tool configured to calculate a provisional score based on the scores received from multiple sources including the accounts, the attendees, and images.

10. The system of claim 1, wherein the confidence interval calculator calculates the confidence intervals based, at least on, historical accuracy, source reliability, and metrics associated with the accounts.

11. A method of score reporting for sporting events, the method comprising:
receiving, at a server, a score associated with a sporting event from an account associated with the sporting event;
calculating a confidence interval associated with the score based on the account and historical data of the account, wherein the confidence interval indicates an accuracy of the score; and
generating a user interface that displays the score and the confidence interval on a web interface.

12. The method of claim 11, further comprising:
creating the account for a user associated with a team playing in the sporting event, wherein the account includes an association type of the user for the account; and
verifying the association type of the user with an administrator associated with the team.

13. The method of claim 12, further comprising:
transmitting a notification to the account at a conclusion of the sporting event prior to receiving the score, wherein the notification includes a score request for the sporting event from the account.

14. The method of claim 11, further comprising:
transmitting a request for the score via a crowdsourced channel hosted by the server;
receiving, at the server, a second score from the crowdsourced channel; and
calculating the confidence interval for the score based, at least partially, on the second score.

15. The method of claim 14, further comprising:
receiving, at the server, an image via the crowdsourced channel; and
extracting the second score using image recognition technology to extract the second score from the image.

16. The method of claim 15, wherein the image recognition technology is capable of extracting the second score from the image that displays a scoreboard or a stat sheet.

17. The method of claim 11, wherein the account includes a confidence weight based at least on an association type of the account with a team playing in the sporting event.

18. The method of claim 17, further comprising:
adjusting the confidence weight of the account based on historical accuracy of previous score submissions provided by the account.

19. The method of claim 17, wherein the confidence interval calculator factors in the confidence weight of the account when calculating the confidence interval of the score submitted by the account.

20. One or more computer storage media storing computer-useable instructions that, when executed by one or more computing devices, cause the one or more computing devices to perform operations comprising:
receive, at a server, a score associated with a sporting event from an account associated with the sporting event;
calculate a confidence interval associated with the score by a confidence interval calculator on the server, wherein the confidence interval indicates an accuracy of the score based on the account; and
generate a user interface that displays the score and the confidence interval on a web interface.
